(19) United States
(12) Patent Application Publication
(10) Pub. No.: US 2002/0032908 A1
(43) Pub. Date: Mar. 14, 2002

(54) System and methods for automatically selecting, mapping and designating components for digital cable service distribution systems

(75) Inventor: Robert C. Booth, Jamison, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 09/932,289

(22) Filed: Aug. 17, 2001

Related U.S. Application Data
(60) Provisional application No. 60/232,533, filed on Sep. 14, 2000.

(51) Int. Cl. H04N 7/173; G06F 3/00; H04N 5/445; G06F 13/00

(52) U.S. Cl. 725/86; 725/37; 725/61

(57) ABSTRACT

A system and methods are provided for selecting head-end equipment and services for digital cable service distribution systems. Enhancing CATV service capabilities to include digital services can be expensive, especially since design and configuration of head-end equipment requires a great deal of engineering expertise. The invention improves efficiency by providing an automated rule-based system and method to help ease that task. The invention also functions to present the listing of required components in a Bill of Material (BOM) format that could be implemented with customer specific pricing structures to facilitate purchase requisition and order fulfillment. Another function of the invention is to facilitate mapping between an end-user display channel, a terrestrial broadcast frequency, and a satellite communications frequency. The relationship between services, service providers, and the necessary component configurations are presented in an easily recognizable format, referred to as a “Channel Map.” These features are provided by a user-interface that permits channel assignment and configuration tasks to be performed more easily. Although the invention is presented in the context of a networked solution, the rule-based system could just as well be implemented on a single computer system.

This application claims priority from co-pending U.S. provisional application No. 60/232,533 filed on Sep. 14, 2000.

### FIELD OF THE INVENTION

The present invention generally relates to a system and method for selecting head-end equipment needed for establishing a set of multimedia services. The invention improves efficiency by partially automating processes that would conventionally be performed manually by service engineers.

### BACKGROUND OF THE INVENTION

Community Access Television (CATV or cable) service was established to allow customers unable to receive terrestrial broadcast reception to receive broadcast services via copper cable. In the past, cable service providers enjoyed the financial benefits of offering more broadcast services than most customers could obtain via their own antenna systems. The cable service providers established a link between broadcast service providers, such as CNN® or HBO®, and customers that wished to receive those services. This was accomplished using equipment specifically designed for enhanced signal-communication, signal processing, and subsequent signal-distribution to the customer. The situation has changed as a result of the introduction of low cost digital Direct Broadcast Satellite (DBS) systems. Over the past number of years, CATV service providers have felt direct competition from digital DBS providers. In an effort to improve services and reduce costs, CATV providers have begun to offer digital cable services in addition to analog services.

Modern satellite communications equipment relays signals across great distances, allowing broadcast service providers to distribute services to a much larger audience than would otherwise be possible. Both analog and digital video communication are common; however digital systems are in demand because they offer increased broadcast-channel carrying capacity through the use of data compression. Digital systems also feature increased immunity to signal degradation, by incorporating error correction protocols in their design. A cable television system operator's signal distribution facility, which typically includes various encoding, digital signal processing, and transmission equipment, is referred to as the “head-end.” Signals received from service providers via terrestrial or satellite communication are decoded and demodulated at the CATV head-end, the frequencies are shifted where necessary, and then re-broadcast to the customer over a distribution network using coaxial or fiber optic cable. Packages of services offered by the cable system operator are also assembled at the head-end. Moreover, billing functions may be handled at the head-end as well.

Expanding a CATV facility to include digital service can be expensive; especially since the selection of head-end equipment currently requires a great deal of engineering expertise. The process typically requires a thorough understanding of the technologies associated with broadband system design and architecture. Similar to computer network operation, digital video communication is based on modulation and demodulation of packetized data streams. Equipment selection is dependent upon the type, the number, and the quality of services that a provider plans to offer. Equipment requirements may change over time, as the provider expands or improves services. As a result of these considerations, the quantity, type, and configuration of head-end equipment supplied to providers varies with the services offered. As these system updates would require recurrent engineering expertise, it is clear that the cost of designing and configuring head-end systems can be significantly reduced by the use of a computer-aided engineering (CAE) system to partially automate the implementation process. A system of this type would also benefit component manufacturers by providing Bill-Of-Material (BOM) capabilities that could be integrated with customer specific pricing structures, thereby automating purchase requisition and order fulfillment. Current systems do not provide this capability.

Automated BOM systems are used in factory automation systems and several patents describe such systems. U.S. Pat. Nos. 5,119,307 and 5,515,269 both describe automated rule-based systems for selecting assembly components and preparing a subsequent bill-of-materials. Those patents do not address the need for a system where the selection of components is directly related to the selection of a group of services. They also do not deal with the implementation of their respective systems over networked architecture.

Computer-assisted design and management tools for Intranet and Internet based networking have been available for some time. Applications developed by Microsoft®, IBM®, Novell® and other companies help system managers more easily configure and control their computer network infrastructures. These tools tend to feature a user-friendly interface, and provide a means for control and configuration of devices across a network. Engineers faced with the task of designing digital cable head-end systems do not currently have these flexible, user-friendly solutions. Creation and configuration of broadcast channel maps that provide a translation between the communication protocols used by service providers and the display of channels observed by customers are typically manually generated. The present invention provides a labor saving solution by providing, inter alia, a partially automated process of performing channel map configuration that also features access from a remote location on a computer network.

### SUMMARY OF THE INVENTION

A rule-based system and method for selecting equipment and services for implementing a digital cable service distribution system is herein described. The system comprises at least one computer processor that can retrieve and process information from a group of data-stores (e.g. computer data-stores). A first data-store comprises a list of broadcast service providers, each logically linked to a set of broadcast services, and a specific transmission channel identifier (e.g. a satellite transponder communication frequency). A second data-store contains system configuration and channel map information. A third data-store holds a dynamic listing of components, selected by the rule-based system from a list of components, needed for providing the services offered by the digital cable service provider. A user interface facilitates dialog between a system designer and the rule-based system. It allows input of information, and selection of service providers and multimedia services offered by the rule-based system. Presentation of resulting service and component selections as well as channel map configuration information is provided in a human comprehensible format.

Access to the rule-based system by the user can be via a local server, or through a computer network, such as an Intranet. The method of selecting services and resulting components begins with initialization of the rule-based system, where each data-store is accessed. Relationships among information comprising the data-stores is logically linked using a relational database, for example. The user interface is initiated whereby the user can interact with the rule-based system. The user selects a service provider and corresponding services from among those presented by the system. The rule representation and evaluation process evaluates the user selections and quantifies component requirements in response to the services requested by the user. The processor selects required components from a list and updates the “selected components” file in the third data-store by adding the requisite components. If the system is to be used for updating an existing installation, required components, as assessed by the rule-based system, are compared to a list of previously existing components. Any required components not found in the third data-store are added to the “selected components” file.

A second function of the present invention is to present the dynamic listing of components, found in the third data-store, in a Bill of Material (BOM) format. The BOM could be implemented with customer specific pricing structures, to facilitate purchase requisition and order fulfillment.

A third function of the present invention is to provide a service identification mapping capability to facilitate mapping between a service identifier (e.g. an end-user display channel), a service delivery system channel identifier (e.g. a broadcast (EIA) channel), and the specific transmission channel identifier associated with that service. The present invention provides a user-interface that permits service channel assignment and configuration tasks to be performed with relative ease by introducing a degree of automation into the process. The relationship between services, service providers, and the necessary components are presented in an easily recognizable format, referred to as a “Channel Map.”

### BRIEF DESCRIPTION OF THE DRAWINGS

FIG. 1 is a schematic diagram of a digital cable head-end system at a cable service provider facility.

FIG. 2 is a block diagram of a client/server system, indicating the flow of information between storage and the user, via a rule-based component selection and service mapping process.

FIGS. 3a and 3b provide an example of the “Current Provider IRTs” (Integrated Receiver Transcoder) view of one possible embodiment of the inventive system in operation.

FIG. 4 is an example of the “IRT List” view of one possible embodiment of the inventive system in operation.

FIG. 5 is an example of a “Channel Map” view of one possible embodiment of the inventive system in operation.

FIGS. 6a through 6k provide detailed process flow descriptions for the rule-based system of the present invention.

### DETAILED DESCRIPTION OF THE INVENTION

The illustrated embodiment details a partially automated system and methods for selecting equipment and services for implementing a head-end service distribution system for digital cable service providers. While the ensuing description is specific for the design of the presented head-end video and audio broadcast system as described herein, it should be understood that the invention could be applied to other configurations. The disclosed embodiment should therefore not be construed as a constraint on the use of the disclosed invention, but rather as an example of one use thereof.

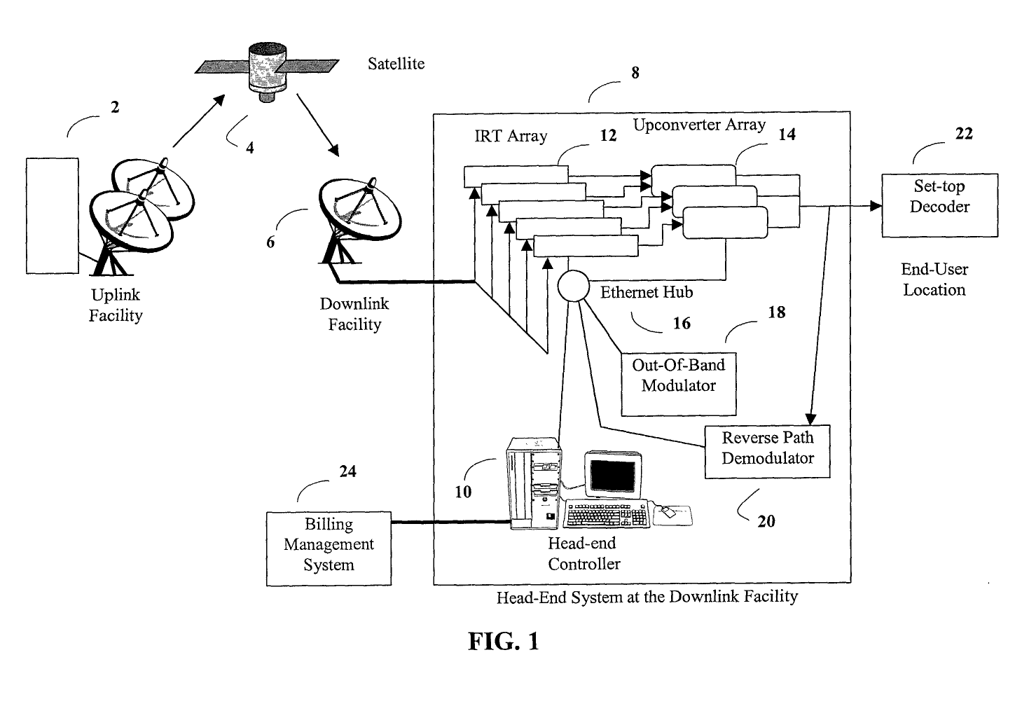

For the purpose of the implementation herein described, communication of digital video and audio signals via satellite can be segmented into two operations, i.e., uplink of digitally encoded services from broadcast service providers to orbital satellites, and downlink of those signals from the satellites to earth-based satellite dish antennas located at cable service provider facilities. FIG. 1 shows the basic components of the system. At the uplink facility 2, analog or digital video and audio signals supplied by broadcast service providers, such as CNN and HBO, are submitted to a head-end system where they are sampled, quantized, and compressed into representative digital signals. After encryption, these signals are packetized and multiplexed onto intermediate frequency (IF) carrier frequencies in the gigahertz (GHz) frequency range, and transmitted to a satellite receiver 4. On-board the satellite, a transponder prepares the signals to be broadcast to Earth stations by amplifying those signals and shifting the IF carrier frequency. Signals received by satellite dish antennas 6 at a downlink facility, are shifted to lower IF frequencies (L-band) by Low Noise Block (LNB) down-converters and data streams are subsequently decrypted, error-corrected, filtered and modulated to an EIA carrier frequency by head-end equipment 8 at the CATV service provider location. The digital signals are propagated to a population of set-top decoders 22 where the signals are decoded, decrypted and demodulated for television viewing at the end-user (e.g., cable subscriber) location.

The following embodiment deals primarily with reception of broadcast services and retransmission of those services from the head-end system at the digital cable service provider location to end-user locations. FIG. 1 shows a typical equipment set-up for a head-end system located at a CATV service provider location. In this implementation, the head-end is composed of the following interconnected elements: a plurality of queuing devices, e.g. Integrated Receiver Transcoder (IRT) 12, a plurality of Analog Signal Processing Upconverters (C6U) 14, at least one controller 10, an Out of Band Modulator 18, a Return Path Demodulator (RPD) 20, and an Ethernet Hub 16. For the remainder of this embodiment, IRTs will be the queuing device of choice, however other queuing devices can be substituted without deviating from the intended application of the present invention. At least one LNB at a satellite dish 6 is connected to an array of Integrated Receiver Transcoders (IRT) 12, each being responsible for tuning to specific L-Band frequencies corresponding to satellite transponder polarizations and frequencies. Each IRT also downconverts and demodulates the received Quadrature Phase-Shift-Key (QPSK) bitstream and converts it into a more bandwidth efficient signal, such as a Quadrature Amplitude Modulation signal (QAM), as well known in the art. Necessary encryption, decryption, error correction, and service filtering duties are also performed by the IRT.

Multiple services are multiplexed onto a carrier frequency for retransmission to the end-users. However, for performance considerations, each IRT can only handle a limited number of services. If the number of broadcast services offered by a single broadcast service provider exceeds the limitations imposed by the transmission and reception equipment, then multiple IRTs would be needed to handle all of the services offered by that provider. The IRT also provides generation and insertion of broadcast service specific data, including display channel, tier level, purchase constraints, price and rating codes, all as well known.

The signals are coupled from the IRT array 12 to an upconverter array 14 that functions to tune the signals output from each IRT to a selectable broadcast Electronics Industry Association (EIA) channel frequency in the range of 54-1000 MHz. A user configurable channel number, also referred to as a “system channel identifier”, identifies each broadcast (EIA) channel. Each upconverter module in the upconverter array can for example, feature two independent upconverters to handle output from two IRTs. In the embodied solution, each IRT/upconverter pair can be under direct control of a networked head-end controller 10, connected through an Ethernet hub 16, allowing configuration of key parameters. A Digital Out-of-Band QPSK Modulator 18 as shown, provides additional information to end-users, such as broadcast service guides (e.g., electronic program guides, often referred to as “EPGs”), code downloads for broadcast service access control and application information.

A Return Path Demodulator (RPD) 20 functions to receive and demodulate, for example, Pay per View (PPV) requests from a set-top decoder 22 at end-user locations. One example of such a decoder is the model DCT-1000 set-top box manufactured by Motorola, Inc. of Horsham, Pa., U.S.A.

The billing management system 24 monitors customer accounts and access control information and communicates this information to service providers and digital cable providers. Other well-known system components (not shown) allow exchange of access and billing information between the uplink facility and the digital cable service provider. It becomes apparent that the design of a system that uses the components described, to provide services to end-users, requires substantial engineering knowledge. Any system design tool that would help relieve this labor-intensive overhead would certainly reduce the cost and complexity of the implementation.

To that end, the present invention assists a system designer with selection of components needed for implementation of a broadcast service system (such as a cable television operator facility) and to present those selections in a Bill-of-Material format. The invention also presents an easily implemented process for automatically selecting services available from broadcast service providers. Moreover, the invention presents the relationship between services, service providers, and the channel numbers displayed to the end-user in an easily recognizable format, such as a Channel Map, which can be saved and recalled for future use.

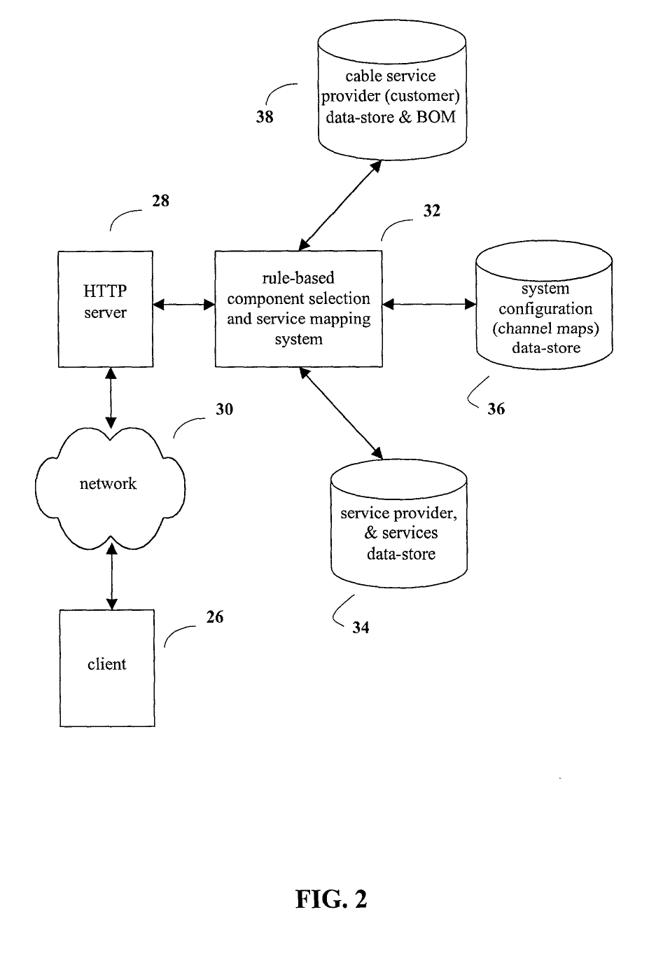

A rule-based CAE application running on a client/server system, as shown in FIG. 2, can assist with the selection of components needed to implement a digital video broadcast service. A client 26 on the system could access a Hyper-Text Markup Language (HTML) encoded form stored on an HTTP server 28 across a network 30. In response to selections of services by users, a rule-based engine 32 would work in conjunction with several sets of data-stores to evaluate component requirements needed to assemble a system that would provide those services. These data-stores include: (i) a set of service providers linked to the services that they offer and the satellite transponders that supply them 34, (ii) a system configuration & channel map data-store 36, and (iii) a cable service provider (customer) data-store 38 that would keep track of existing equipment at a cable service provider facility and provide information concerning necessary additional equipment requisitions. This data-store would also store a file of user selected services. The application of these data-stores to an embodiment of the present invention will become clear during discussion of the methodology to follow.

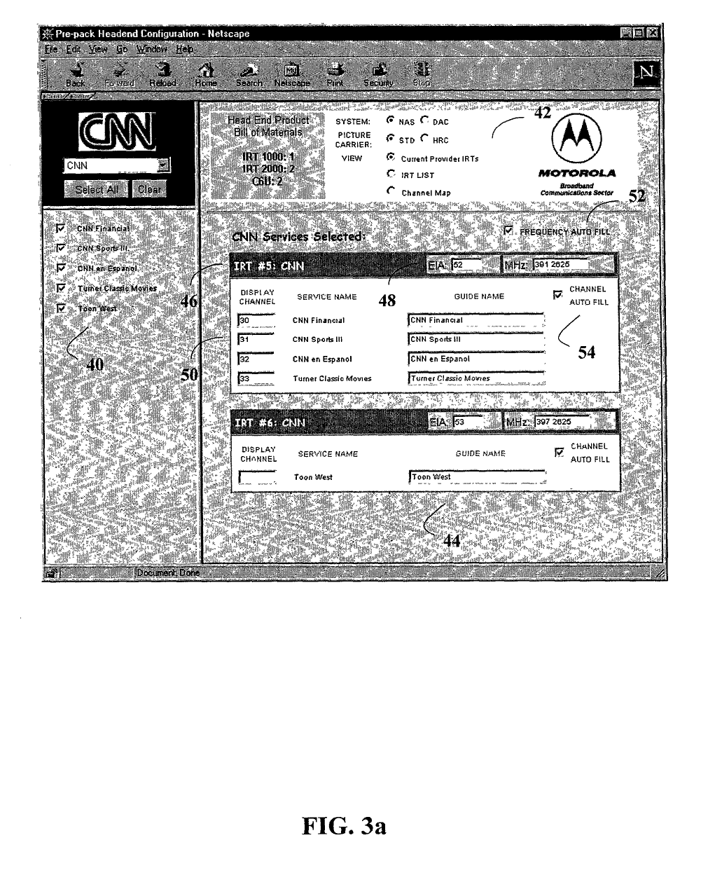

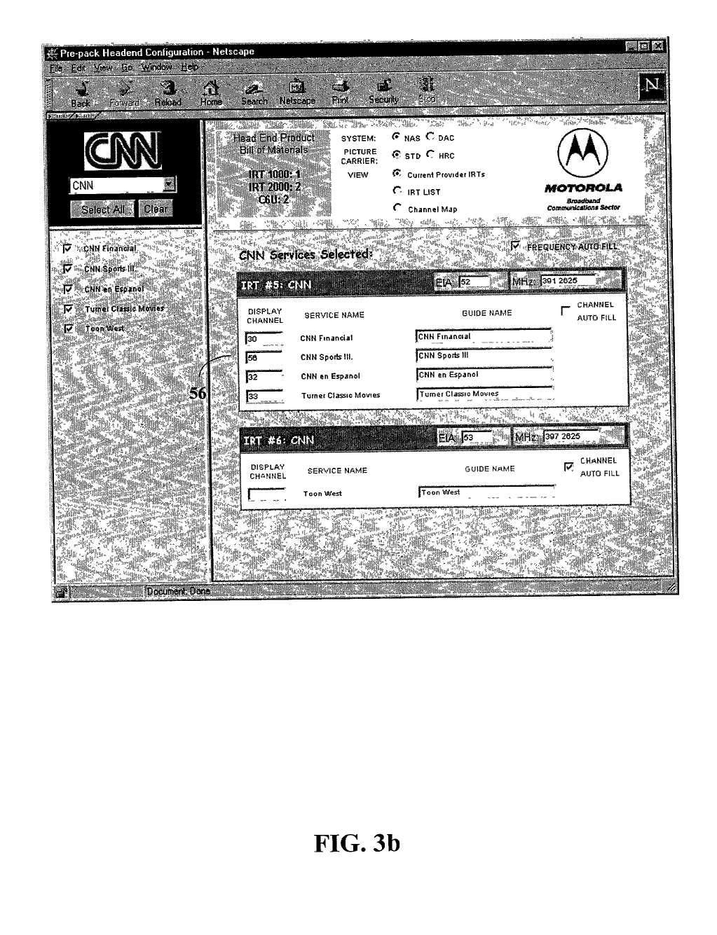

A representative user-interface for this preferred embodiment is shown in FIGS. 3 through 5. The user interface is implemented as an Internet browser client document using a combination of any of a plurality of HTML, Extended Markup Language (XML), scripting or application-specific document encoding schemes. The displayed document is divided into three sections, referred to as “frames” in the HTML vernacular. The first frame 40 shown in FIG. 3a is separated from the remainder of the document by a vertical border. Within this frame is positioned a method for displaying and selecting broadcast service providers and the services that they offer. The second frame 42 shown in FIGS. 3 through 5 is entitled “Head-End Product Bill of Materials” and is separated from the larger main area by a horizontal border. Within this section, a summarized Bill of Material (BOM) is shown. Also within this section, a user can select one of three possible display formats to be shown in the third frame by selecting one of the choices under the “View” heading. The user can also select from other system configuration options such as “System” or “Picture Carrier.” The third frame 44 displays the view format selected by the user. The views selected can be one of “Current Provider IRTs”, “IRT LIST”, or a “Channel Map.” FIG. 3a shows the layout of the “Current Provider IRTs” view. Configuration parameters for two IRTs are shown, IRT #5 46 and IRT #6. Each IRT/Upconverter pair is responsible for broadcasting at a single EIA channel frequency 48, and functions to multiplex a set of services onto that channel. The display channels 50 (also referred to as “service channel identifiers”) corresponding to those services that are configurable by the system designer and added to the bitstreams that are sent to the end-user. The “Frequency Auto Fill” 52 and “Channel Auto Fill” 54 functions impart a degree of automation to the system configuration.

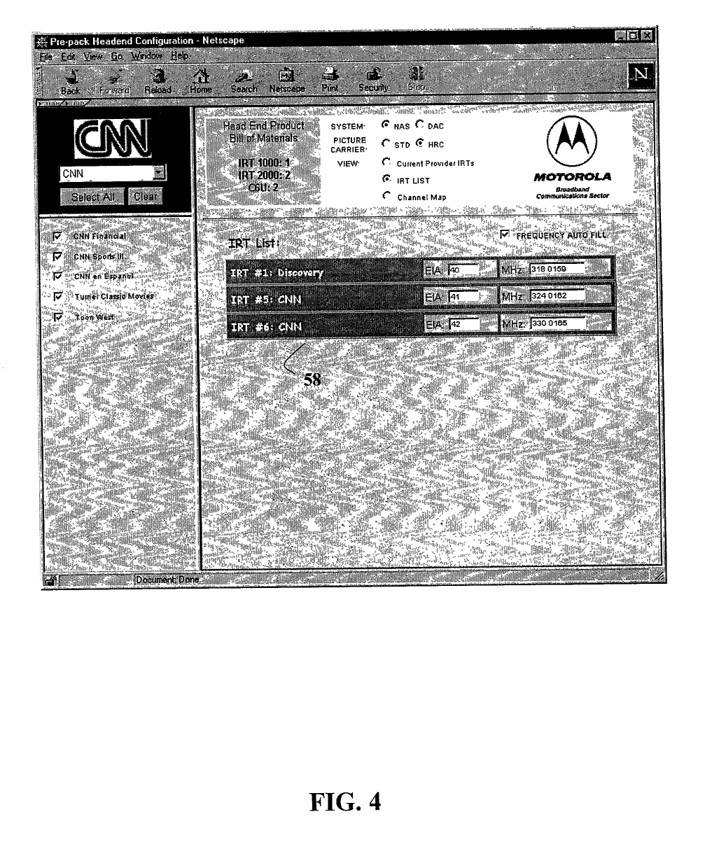

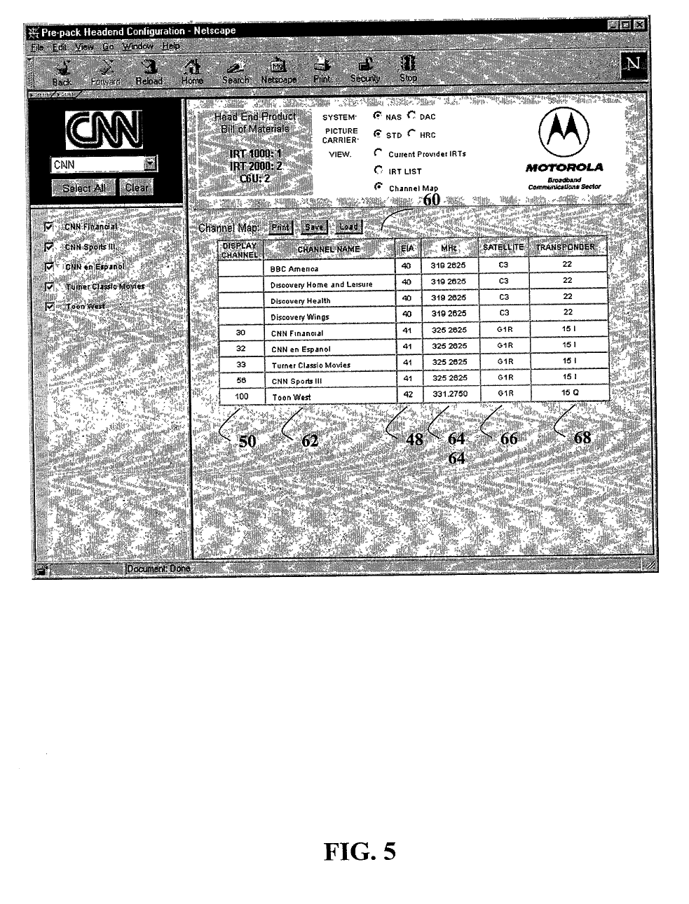

The “IRT LIST” view is shown in FIG. 4, where a list of selected IRTs 58 is displayed along with their respective broadcast (EIA) channels. FIG. 5 is an image of the “Channel Map” view 60, where a summary of display channels 50, channel (service) names 62, broadcast (EIA) channels 48, broadcast frequencies 64, satellite 66, and transponder 68 descriptions are shown. In the following methodology, the operational functionality of elements within each of these views will be described in detail.

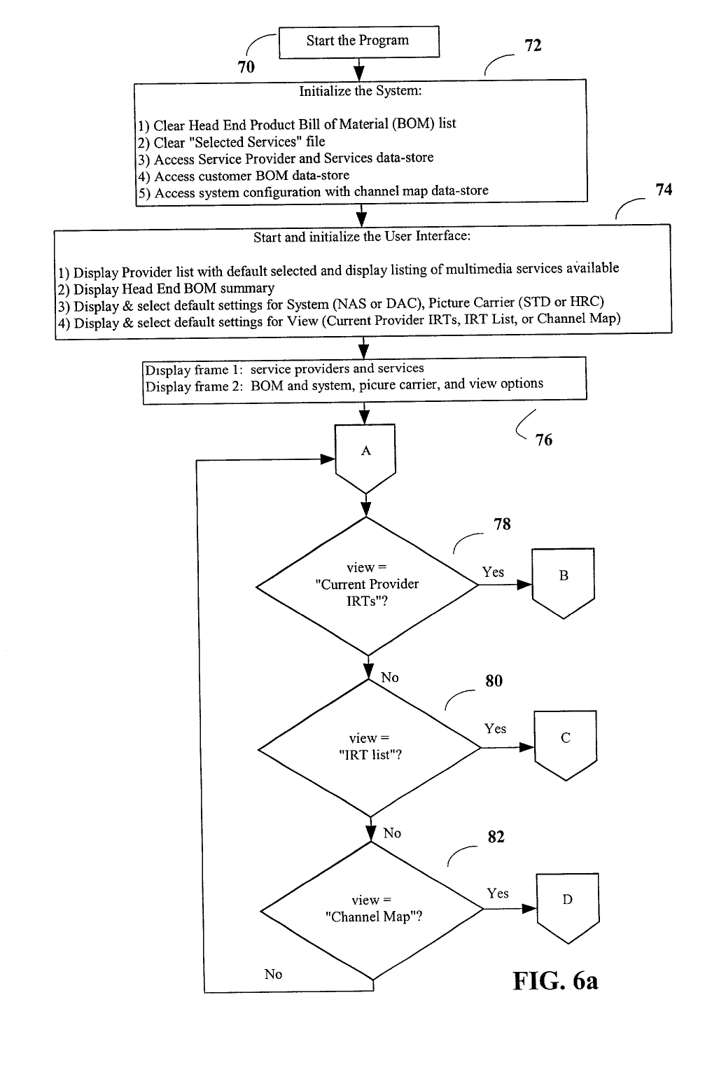

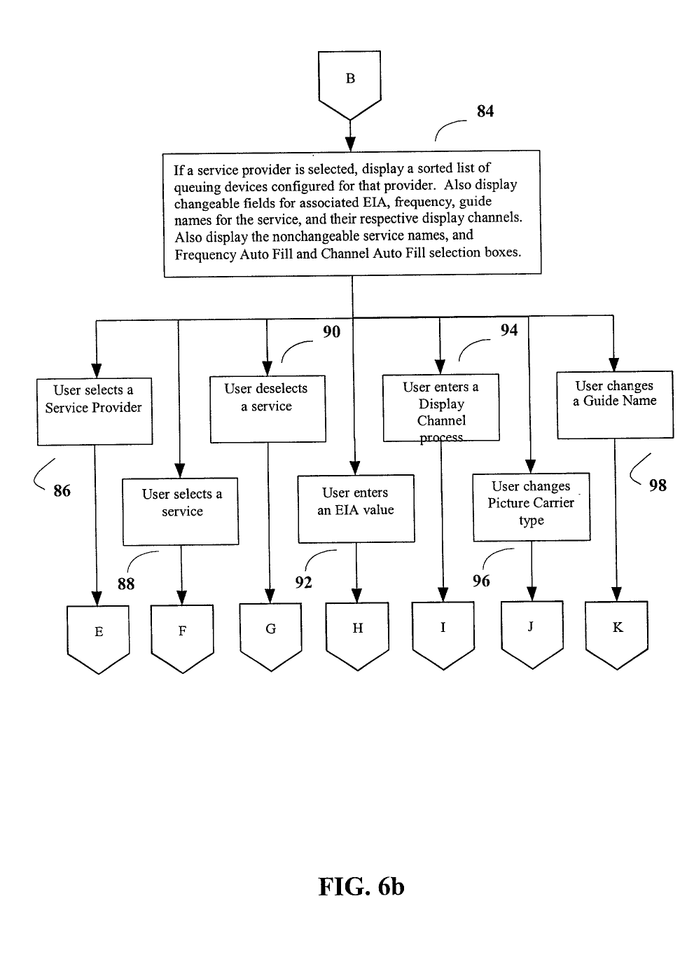

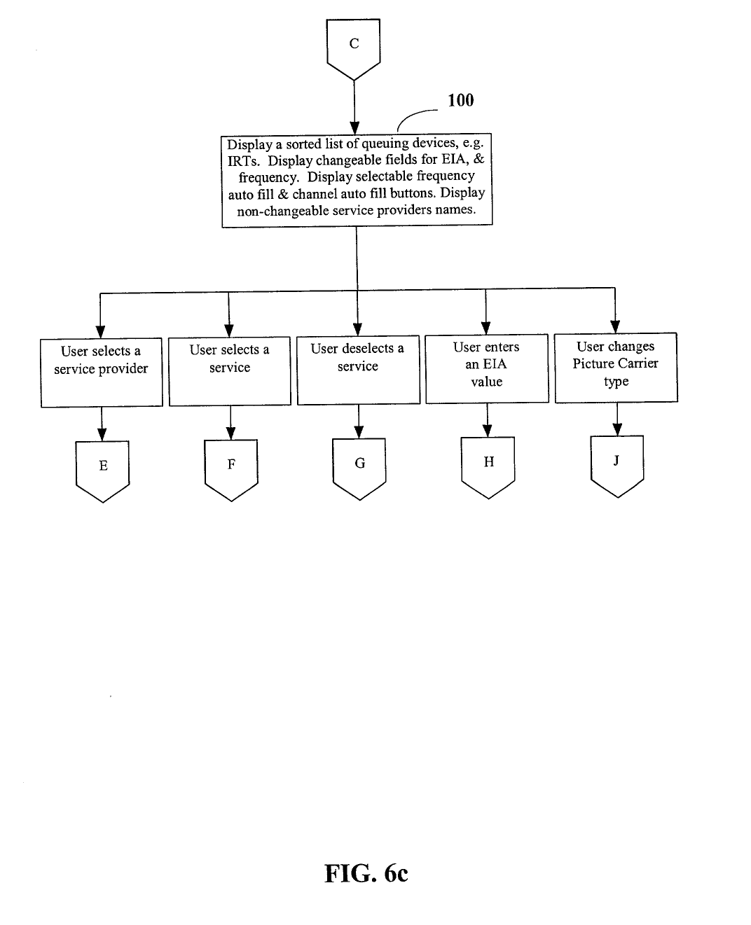

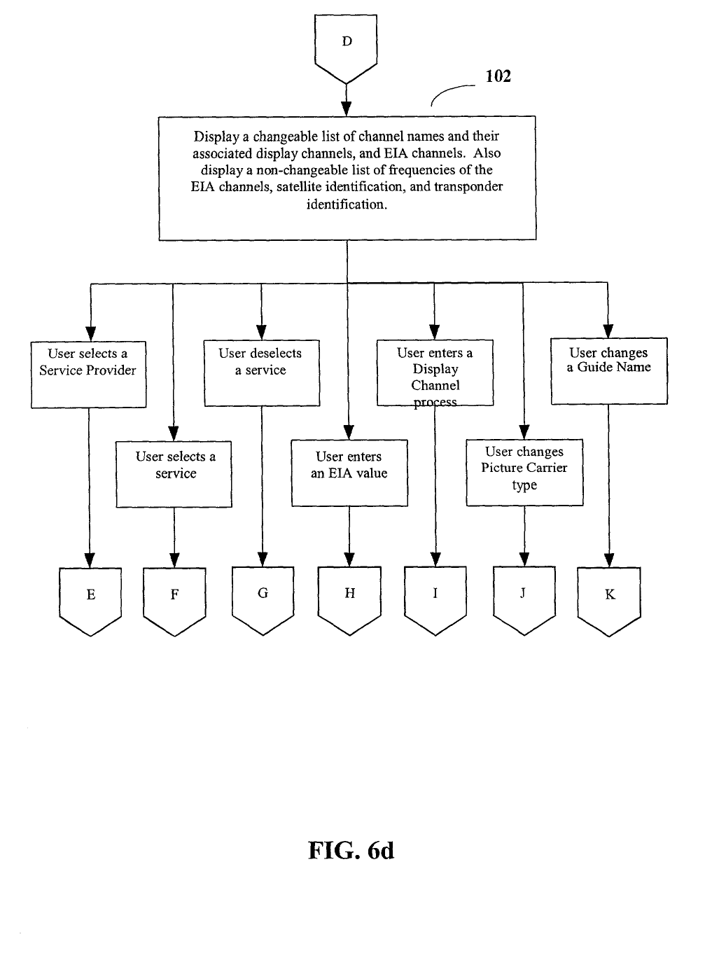

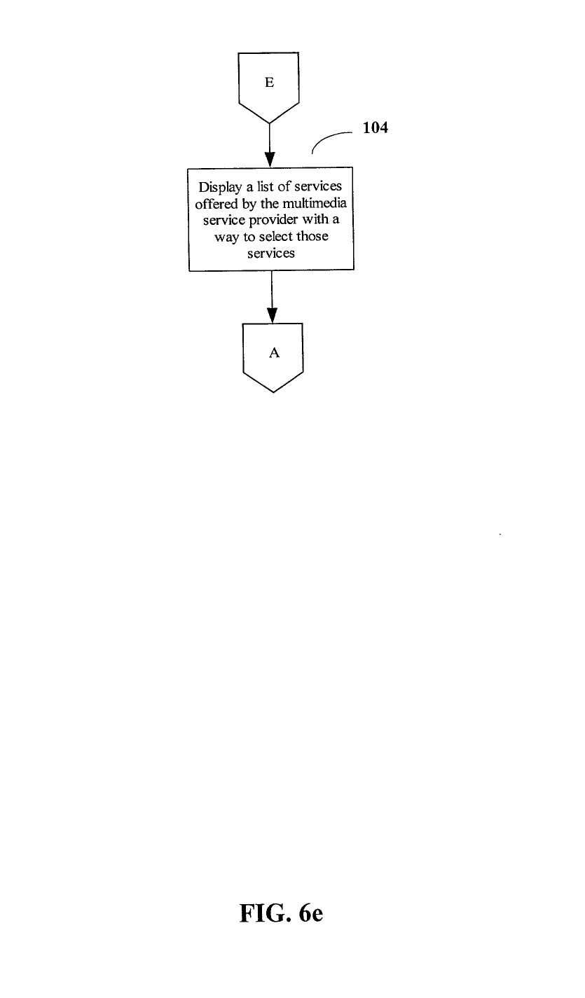

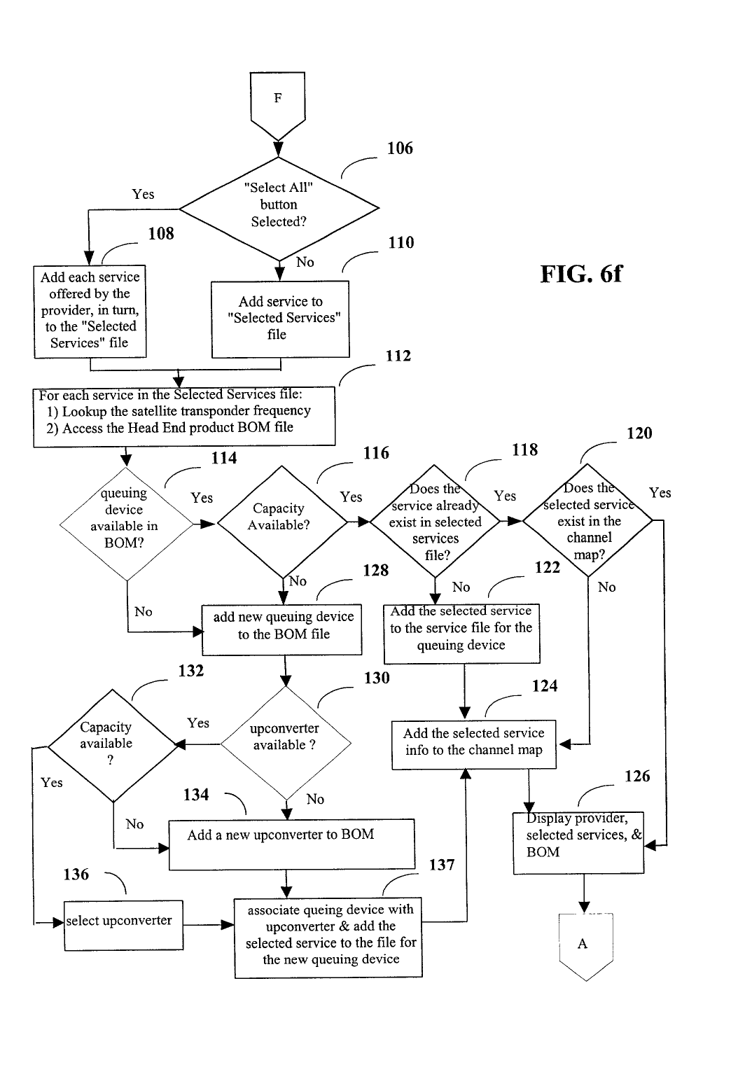

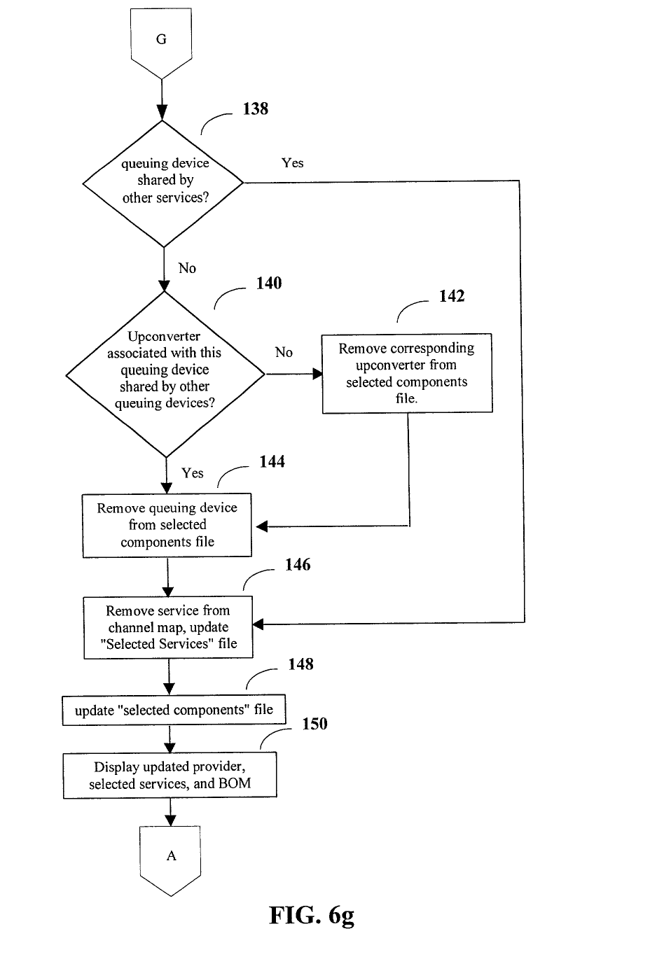

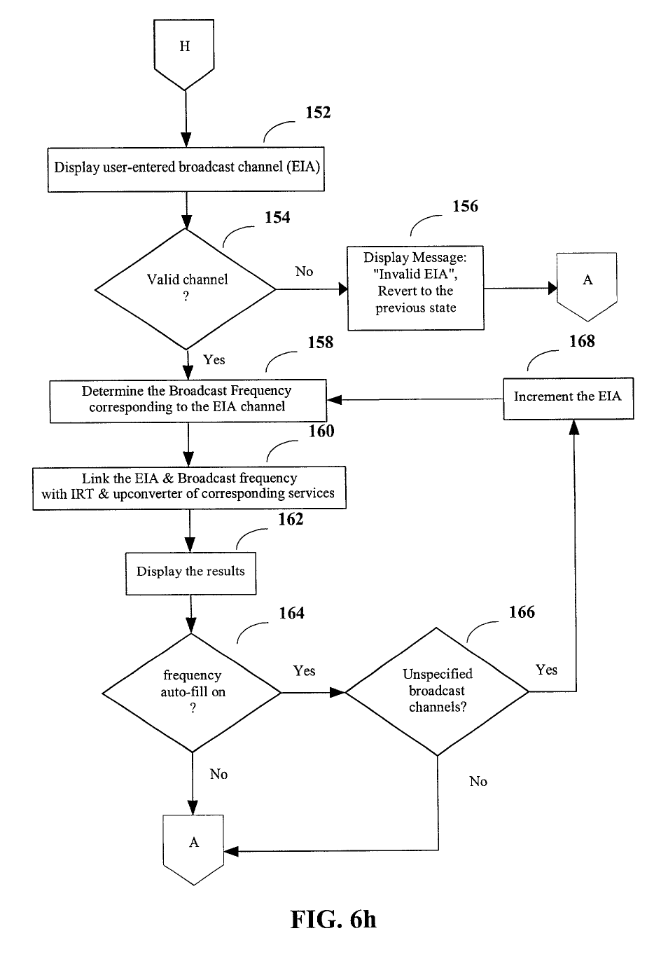

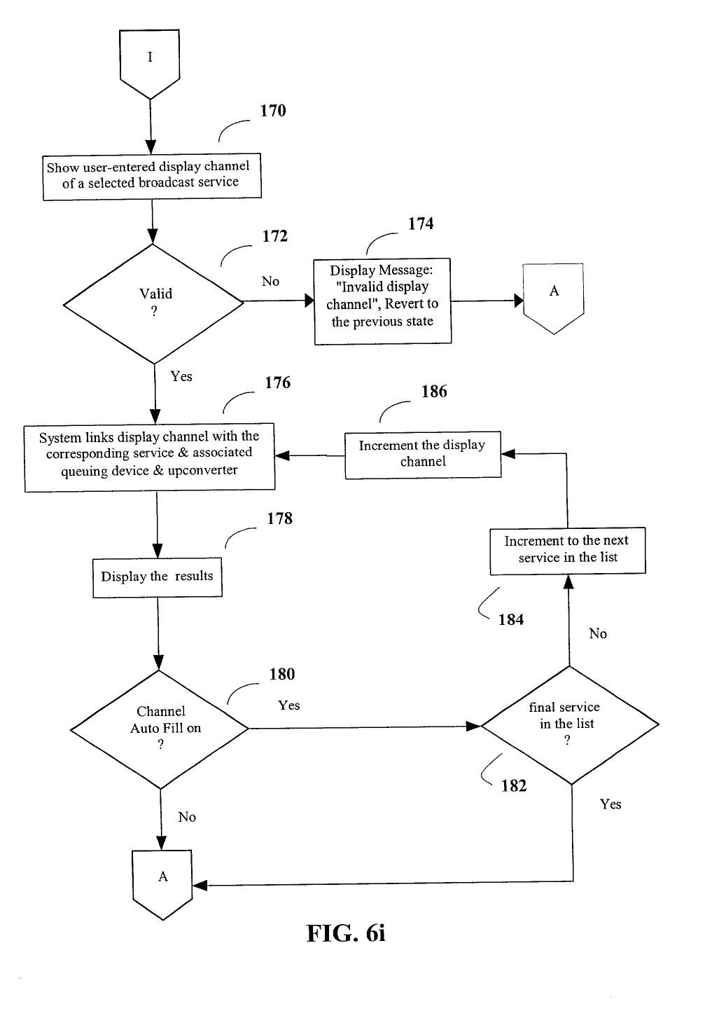

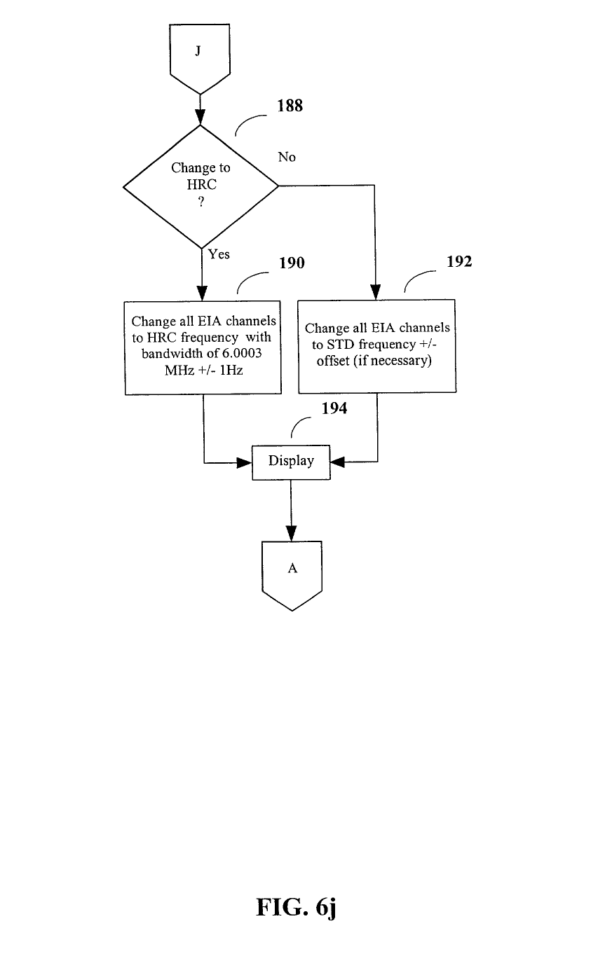

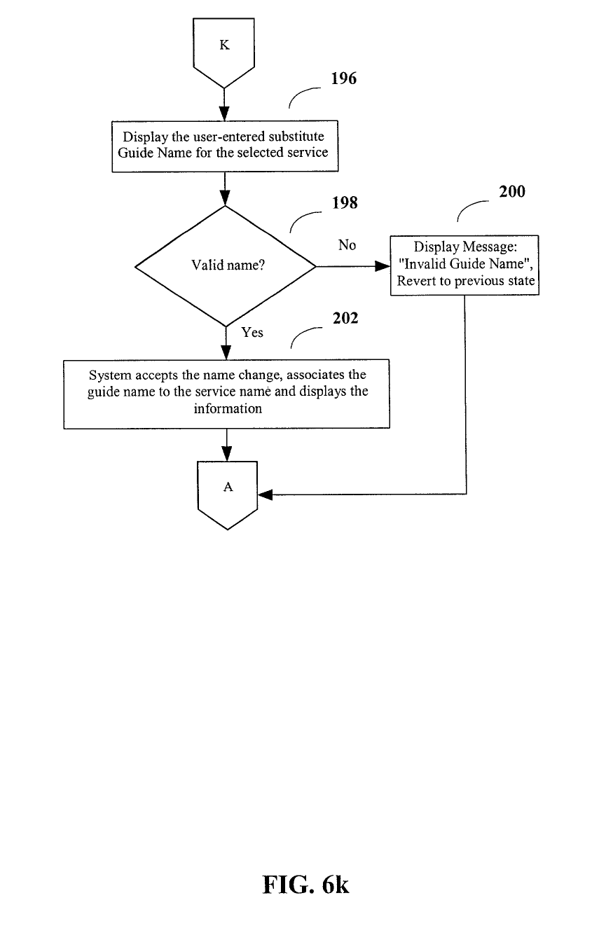

The operation of the present invention is detailed in FIGS. 6a through 6k. A user accesses the system design and service selection program either remotely or at the server on which the program resides, as indicated at box 70. The process begins at FIG. 6a, where first time use of the system by a user entails initialization 72 of the system by clearing from memory information previously specified by other users and providing access to data-stores required by the system. Alternatively, system initialization could include loading a previous configuration into the system run-time resources, and editing the elements of that configuration. These data-stores include a catalog of service providers 34 (e.g. CNN shown in FIG. 3a) and services that they offer (e.g. CNN financial, CNN sports, Toon West, also shown in FIG. 3a), and satellite and satellite transponder frequencies linked to each of the services offered by the listed service providers. System configuration and channel maps are also provided 36. A cable service provider data-store 38 provides an inventory of existing equipment at a service facility and retains an updated BOM of necessary additional equipment requisitions.

The user interface 74 previously described is presented in a format designed to work with the client system. For the implementation shown in FIGS. 3 through 5, the first and second frames are always displayed, as indicated at box 76. The content of the third frame, however, is subject to a “VIEW:” that can initially be specified by a system default setting. Other default settings that might be specified as part of the system initialization include “SYSTEM:” and, “PICTURE CARRIER:.” In FIG. 3a, the initial “VIEW:” setting is “Current Provider IRTs.” After system initialization, the user can select one of the alternate views provided by the system. Either “Current Provider IRTs” view (box 78), in which case the process continues at box 84 of FIG. 6b, “IRT list” view (box 80), in which case the process continues at box 100 of FIG. 6c, or “Channel Map” view (box 82), in which case the process continues at box 102 of FIG. 6d can be selected. Each of these views allows the user to change a set of configuration parameters. For the purpose of selecting a set of services to be offered to end-users, the “Current Provider IRTs” view is most appropriate. Continuing from box 84 on FIG. 6b, at system initialization, if no services have been previously selected for the service provider displayed in the second frame, then the third frame remains empty until services are selected. Changes in any input field results in analysis of data and subsequent display of the results. This view supports the following procedures: select a broadcast service provider (box 86), select services (box 88), deselect services (box 90), specify EIA channels (box 92), specify display channels (box 94), change a picture carrier type (box 96), and specify a name for services in a service guide (box 98).

If a user wants to select and configure services offered by an alternate broadcast service provider, the provider is selected from a list, as indicated by a pull-down menu shown in FIGS. 3 through 5. The select service provider process 86 begins, and the process continues as shown on FIG. 6e. The result (box 104) of initiating this process is to display a selectable list of services offered by the broadcast service provider. If the user selects one or more services offered by the provider, then the select service procedure is initiated at box 88. The procedure continues on FIG. 6f by evaluating system equipment changes that would need to be made to fulfill those services. If the “select all” button shown in FIG. 3 through FIG. 5 is selected by the user (box 106), each service in turn is added to a “selected services” file (box 108) and stored in memory. If the “select all” button is not selected, then the service selected by the user is added to the “selected services” file at box 110.

For each service selected for a particular service provider, a value for the transponder frequency is retrieved from storage that corresponds to that selected service (box 112). The service provider BOM listing is also retrieved. Since each IRT is responsible for tuning, indirectly, to a specific transponder frequency, the retrieved BOM would indicate whether the service provider already had an IRT that could receive those signals, as indicated at box 114. If one were available, the next task would be to ascertain whether the IRT has sufficient capacity, as indicated at box 116, to decode the incoming signal reliably. While multiple channels can be compressed, packetized, and multiplexed onto a single carrier frequency, performance considerations limit the number of channels that can be accommodated. As a result, multiple IRTs might be required to receive all the desired services that a service provider offers. If a suitable IRT with sufficient capacity were available, then a system query would determine if the service already existed in the “selected services file”, box 118. If the service does exist, then a system query would determine if the service exists in the channel map as shown in box 120. In the case where the service does not already exist in the “selected services file”, the service would be added to the selected services file for that IRT, as shown in box 122. Thereafter, the selected service would be added to the channel map, as shown in box 124. Returning to box 120, if the service does not exist in the channel map, then the selected service information is added to the channel map, box 124. If the service does exist in the channel map, then the information is displayed to the user, box 126. Returning to box 116, if a suitable IRT were not available, then a new IRT would need to be added to the BOM for the head-end design (box 128).

In addition to the IRT, an analog signal processing upconverter 14, is required to process the incoming digital signals and convert the frequency output from the IRT to a broadcast (EIA) frequency appropriate for transmission to the end-user. Since each upconverter in the present example can accommodate two IRTs, fewer of these units are required to handle the service load. After selecting an appropriate IRT, a search of the cable service provider component BOM is initiated for the presence of an upconverter as indicated at box 130 having the necessary capacity (box 132) to process signals from an IRT. If one exists, then the upconverter would be selected (box 136) and associated with the IRT, shown at box 137. The service would also be added to the “selected services file” for that IRT. If one were not available, a new upconverter would be added (box 134) to the BOM for that cable service provider and associated with the IRT and the service would be added to the “selected services file”, as indicated by box 137. The selected services would also be added to the channel map (box 124). Finally, the resulting list of providers, the selected services, and a BOM would be displayed to the user (box 126). The system would then wait for the next selection by the user.

If a user wished to deselect a service (box 90) from the file of selected services of a broadcast service provider, the BOM would also have to be updated to reflect changes in equipment requirements. Following on FIG. 6g, the system would first ascertain whether the IRT and upconverter that was previously set up to handle the selected service is currently shared by other services, as shown at boxes 138 and 140. If neither were found to be shared, then the respective components would be removed from the data-store of selected components (boxes 142 and 144). Alternatively, if either component is found to be a shared resource, then the list of components in the digital cable service provider data-store would be updated to reflect the increase in capacity for the affected components, as indicated at box 148. These changes would be communicated to the user through the user interface (box 150). The system would then wait for the next selection by the user.

If a user wished to specify a broadcast (EIA) channel associated with a particular set of services (box 92), the EIA channel number and the associated broadcast frequency would need to be specified. A user would specify an EIA channel for a particular set of services by entering an integer in an EIA channel input field 48 associated with an IRT that handles that set of services, as shown in FIG. 3a. Looking at FIG. 6h, the user-selected EIA channel (box 152) would be compared against a set of already assigned EIA channels to avoid any assignment conflicts, as shown at box 154. If an assignment conflict were detected, an error message indicating this situation would be displayed (box 156), the system and the input field would revert to the previous state, and the process would end. The user could reinitiate the process by entering another value into the EIA channel input field. Upon detection of a valid EIA, the corresponding RF broadcast frequency would be assigned to that channel, as shown at box 158, and the EIA and corresponding frequency would be logically linked, in storage, to the corresponding set of services that are assigned to that channel (box 160). The resulting EIA channel and frequency assignments would be displayed to the user, as shown at box 162. If the frequency Auto Fill function were selected by the user (box 164), any unspecified broadcast (EIA) channels (box 166) for that broadcast service provider, would be specified by the system automatically by incrementing the EIA channel assignment value as shown at box 168. Process steps 158 through 168 would be repeated as necessary. The system would then wait for the next selection by the user.

One responsibility of the head-end system is to assign display channels 50 to the individual services that are multiplexed onto the EIA channel. These individual display channels are included with the service data stream and referenced by the end-user through the set-top digital consumer terminal (DCT) 22. A user enters a display channel in the input field connected with a broadcast service in the user interface (box 94). The assignment process begins on FIG. 6i as the entered display channel is sent to the system for evaluation and the value is displayed to the user, as shown at box 170. If the chosen display channel had previously been assigned to another service (box 172), an error message would be shown (box 174), the system and the input field would revert to the previous state, and the process would end. The user could reinitiate the process by entering another value in the display channel field. If there is no assignment conflict, the system would logically assign this display channel to the corresponding service and in so doing also assign the display channel to a particular IRT and upconverter (box 176). The results are displayed to the user through the user interface (box 178) as shown in FIG. 3a. If the channel Auto Fill function is also selected (box 180), a query is performed to assess whether additional services are assigned to the same IRT that would require channel assignments (box 182). If so, the next listed service would be selected for processing (box 184) and a channel would automatically be assigned by incrementing the display channel for that corresponding service, as shown at box 186. Processes 176 through 186 would be repeated, consecutively, for each of those services. A user could also change the display channel of a previously configured service by turning off the channel Auto Fill function and substituting a replacement display channel value (box 56), as shown in FIG. 3b. The system would then wait for the next selection by the user.

The broadcast carrier frequency for transmitting an EIA channel is subject to the picture carrier protocol used by the service provider. Two representative picture carrier protocols are STD (standard carriers) and HRC (harmonically related carriers). These two protocols differ by the location of the lower edge of their respective channel frequencies. STD channels are subject to offsets at certain carrier frequencies because of conflicts with aeronautical communication channels. HRC improves system performance and allows signal carriers to be spaced 6.0003 MHz apart. Toggling between these two carrier frequency standards, as shown at box 96 of FIG. 6b, by selecting and deselecting the radio button shown in frame 2 in FIG. 3a, requires the system to change each of the broadcast (EIA) frequencies for all of the selected services. The process is shown in FIG. 6j. If changing to the HRC protocol from STD (box 188) then all EIA channel specifications would be changed to reflect the new carrier frequencies (box 190). If changing to the STD protocol from HRC, then all EIA Channel specifications would reflect these carrier frequencies taking the offset frequencies into account, as shown at box 192. Those configuration changes would be displayed in the user interface and recorded in the cable service provider data-store. The system would then wait for the next selection by the user.

The cable service provider can change the service names into alternate names that the provider can publish in electronic guides transmitted to the end-user by the Out-of-Band modulator 18 of FIG. 1. The user evokes a procedure (box 98) that allows these assigned names to be changed by substituting a replacement guide name in the selected “Guide Name” input field, as shown in FIGS. 3a and 3b. While the alternate name would be sent to the system for evaluation it would be shown in the respective “Guide Name” field as well (box 196). As shown in FIG. 6k, the name would be checked for conflicts against a set of previously entered guide names (box 198). If the chosen guide name had previously been assigned to another service, an error message (box 200) would be displayed, the system and the input field would revert to the previous state, and the process would end. The user could reinitiate the process by entering another value in a Guide Name field. If a valid name had been entered, the resulting guide name would be associated with the respective service name in (box 202). The system would then wait for the next selection by the user. Returning to FIG. 6a, if the user chooses to view the “IRT list” (box 80), the procedure continues on FIG. 6c. A listing of all selected, and sorted IRTs is displayed (box 100). One example listing is shown in FIG. 4. The name of the service provider, as well as the selected broadcast (EIA) channels and their respective carrier frequencies, are displayed next to the corresponding IRT, provided that those fields have already been configured. If EIA channels for groups of services have not been specified, then those fields are left unfilled. In this view mode, the following procedures are supported: select broadcast service provider 86, select new services 88, deselect services 90, specification of broadcast (EIA) channels 92, and change of picture carrier type 96. Each of these processes function as previously discussed.

Returning to FIG. 6a, if the user selects the “Channel Map” view 82, the procedure continues as shown in FIG. 6d, at box 102, where a user-configurable listing of all selected channel names 62, their corresponding display channel assignments 50, and broadcast (EIA) channel references 48 are displayed as shown in FIG. 5. Also displayed are the respective broadcast frequencies 64, satellite 66 and transponder identifications 68. In this display mode, all procedure types previously described are supported and function as previously discussed. Working within this view mode, the user can load previously configured Channel Maps, save existing channel maps and print those Maps as well.

After completion of the head-end design procedure, the BOM would give a listing of equipment needed to deploy the system. The BOM could be linked to a factory order fulfillment and delivery system where all the necessary components could be sent to the user for installation. Customer specific pricing could be implemented by linking that information to the BOM received from the cable service provider. If the design specifications were also sent to the head-end component manufacturers, the components could be configured at the factory to help ease installation responsibilities of the user.

In the embodiment described above, exchange of billing information between the cable service provider and the uplink facility was not described. Digital cable can include Pay-Per-View (PPV) services that require equipment, and setting of configuration parameters that facilitate exchange of end-user information for assignment of access rights to services. The described embodiment may include those capabilities within the system design process.

It should now be understood that the invention provides a system and method for assisting in the design of a digital head-end broadcast facility by at least partially automating the component selection needed for that implementation, and to present that selection in a BOM format. The invention also presents a process for selecting services to be broadcast from a list of available services provided. The invention further provides a means to organize and present in an easily recognizable format such as a Channel Map, the identification of services, service providers, and the components that provides those services.

Although the invention has been described in connection with various specific embodiments thereof, it should be appreciated that various modifications and adaptations can be made without departing from the scope thereof, as set forth in the claims.

What is claimed is:

1. A rule-based system for selecting components and services for a service delivery system comprising:
at least one computer processor associated with:
(a) a first data-store of service providers, each service provider being logically linked to a set of services, each service being logically linked to a transmission channel identifier,
(b) a second data-store of service delivery system configuration and channel map information, and
(c) a third data-store for holding a dynamic listing of selected components chosen from a list of components in response to user input;
a user interface operatively associated with said processor for enabling dialogue between a user and the rule-based system, said dialogue comprising input means for selection of service providers and offered services, and presentation means for presenting selected services and service delivery system components; and
a service identification mapping capability to provide mapping between a service identifier, a service delivery system channel identifier, and a transmission channel identifier;
wherein said rule-based system quantifies service delivery system component requirements in connection with the selected services, and said processor applies rules to evaluate input parameters and selects service delivery system components based thereon.

2. The rule-based system of claim 1 wherein said interface further comprises an input data recognition process for classification of data input by the user.

3. The rule-based system of claim I wherein insertion and changes to at least one of said services, service providers, and service delivery system components are possible.

4. The rule-based system of claim 1 wherein said processor interacts with other elements of said rule-based system over a network.

5. The rule-based system of claim 1 wherein said processor interacts with the components of said service delivery system over a network.

6. The rule-based system of claim 1 wherein data generated by said rule-based system is provided to substitute for user-generated data input via said user interface.

7. The rule-based system of claim 1 wherein a service delivery system component listing is provided in a bill-of-material format.

8. The system of claim 7 wherein said user can examine said bill-of-materials, said service provider listing, said set of services, and their respective channel identifiers in a representation mutually agreeable to the system and the user.

9. The rule-based system of claim 1 wherein said services are delivered via a network.

10. The network of claim 4 wherein said network is at least one of a broadcast, interactive, cable, telephone, wireless, HFC, coaxial, twisted-pair, DSL, Ethernet, fiber optic, and TCP/IP network.

11. A rule-based method for selecting components and services for a service delivery system, where system initialization comprises the steps of:
populating a first data-store with (i) service providers, (ii) sets of services, and (iii) a transmission channel identifier for each service in said data-store;
logically linking transmission channel identifiers with services; and
further logically linking each set of services with the corresponding service provider.

12. A rule-based method for selecting components and services for a service delivery system, where a user and rule-based system dialogue comprises the steps of:
initiating a user interface, wherein a rule representation and evaluation process is enabled, and said user interface subsequently provides information exchange between the user and the rule-based system; and
enabling the user to select from among system components, service provider and corresponding service information,
wherein the rule representation and evaluation process evaluates and validates said user selections and determines any additional components required to administer said services.

13. The method of claim 12 wherein component requirements and selected services are communicated to said user through the user interface.

14. The method of claim 12 wherein the user can elect to remove any of said services from previously entered selections in an interactive manner, and the rule representation and evaluation process automatically updates component requirements for the resulting services selected.

15. The method of claim 12 wherein the user can elect to choose additional services from said service providers in an interactive manner, and the rules representation and evaluation process automatically updates component requirements for the resulting services selected.

16. The method of claim 12 wherein the rule representation and evaluation process provides a mapping between a service channel identifier, a system channel identifier, and a transmission channel identifier for each set of selected services.

17. The method of claim 12 wherein the rule representation and evaluation process configures values for input parameters necessary for the implementation of said system, based upon an initial entry of a single instance of a value for that parameter.

18. The method of claim 12 wherein the user can elect to receive an output of said bill-of-materials, said service provider listing, said set of services, and their respective service channel identifiers in a representation mutually-agreeable to the user and the rule-based system.

19. A machine readable media containing program code for a rule-based system to at least partially automate the selection of components and services for a service delivery system, wherein:
said program code includes instructions for at least one computer processor associated with:
(a) a first data-store of service providers, each service provider being logically linked to a set of services, each service being logically linked to a transmission channel identifier,
(b) a second data-store of service delivery system configuration and channel map information, and
(c) a third data-store for holding a dynamic listing of selected components chosen from a list of components in response to user input;
said program code implements a user interface operatively associated with said processor for (i) enabling dialogue between a user and the rule-based system, said dialogue including selection of service providers and offered services, and (ii) presenting selected services and service delivery system components;
said program code provides a service identification mapping capability to provide mapping between a service identifier, a service delivery system channel identifier, and a transmission channel identifier;
said rule-based system quantifies service delivery system component requirements in connection with the selected services; and
said processor applies rules to evaluate input parameters and selects service delivery system components based thereon.

20. A machine readable media containing program code for implementing a rule-based method enabling a user to select components and services for a service delivery system, said program code:
(i) initiating a user interface, wherein a rule representation and evaluation process is enabled, and said user interface subsequently provides information exchange between the user and the rule-based method; and
(ii) enabling the user to select from among system components, service provider and corresponding service information,
wherein the rule representation and evaluation process evaluates and validates said user selections and determines any additional components required to administer said services.
